(19) United States
(12) Patent Application Publication
(10) Pub. No.: US 2023/0014276 A1
(43) Pub. Date: Jan. 19, 2023

(54) COOLING SYSTEM AND METHOD FOR AN ELECTRICAL AIRCRAFT PROPULSION SYSTEM

(71) Applicant: Airbus Operations S.L.U., Getafe (ES)

(72) Inventors: Carlos Bueno Vazquez, Getafe (Madrid) (ES); Jorge Molano Rembiasz, Getafe (Madrid) (ES); Ji Xu Xu, Getafe (Madrid) (ES)

(21) Appl. No.: 17/862,814

(22) Filed: Jul. 12, 2022

(30) Foreign Application Priority Data
Jul. 13, 2021 (EP) 21382633.2

(51) Int. Cl. B64D 33/08; B64D 27/24; B60L 58/33

(52) U.S. Cl. CPC B64D 33/08; B64D 27/24; B60L 58/33; B60L 2200/10

(57) ABSTRACT

The cooling system includes an energy source, one or more heat exchangers for cooling a coolant, the one or more heat exchangers being connected to the energy source by a coolant circuit, one or more air channels inside which the one or more heat exchangers are placed, wherein the coolant circuit includes a bypass portion that recirculates the coolant to the energy source or circulates the coolant from the energy source to the one or more heat exchangers. The method includes decreasing the temperature of a portion of a coolant below an operating temperature, acting this portion of the coolant as a thermal buffer, and maintaining the rest of the coolant at the operation temperature. They allow enhancing the cooling capabilities of the system during the take-off phase, especially during the beginning of this phase.

### CROSS-REFERENCE TO RELATED APPLICATION

This application claims priority to European patent application number 21382633.2 filed on Jul. 13, 2021, the entire disclosure of which is incorporated by reference herein.

### TECHNICAL FIELD

The disclosure herein refers to a cooling system and method for an electrical aircraft propulsion system, that applies to the procedures to be performed by thermal management controller or the crew before take-off phase.

### BACKGROUND

Before and during the taking-off of an aircraft the electrical propulsion system of the aircraft must be cooled to prevent damages.

For this cooling, the aircraft comprises channels through which ram air flows.

After the aircraft takes-off, the speed of the aircraft improves the air flow through ram air channels.

The sizing of these ram air channels is important because it is necessary a balance between the cooling needs before, during and after the taking-off of the aircraft.

If the sizing of these ram air channels is reduced, it would affect the cooling before and during the taking-off, and if the sizing of these ram air channels is increased, it penalizes the global performance of the aircraft, leading to an inefficient design.

### SUMMARY

Therefore, one purpose of the disclosure herein is a cooling system and method for an electrical aircraft propulsion system, which allows optimization of the size the ram air channels in all the phases of the operation of the aircraft, before, during and after the taking-off.

With the cooling system and method according to the disclosure herein it is possible to solve the drawbacks, providing other advantages that are described below.

According to a first aspect, the disclosure herein refers to a cooling system for an electrical aircraft propulsion system, comprising:
an energy source that drives the propulsion system,
one or more heat exchangers for cooling a coolant, the one or more heat exchangers being connected to the energy source by a coolant circuit,
one or more air channels inside which the one or more heat exchangers are placed,

wherein the coolant circuit comprises a bypass portion that:
recirculates the coolant to the energy source; or
circulates the coolant from the energy source to the one or more heat exchangers.

Advantageously, the one or more air channels comprises one or more fans.

According to a preferred embodiment, the energy source is a fuel cell.

Preferably, the coolant circuit comprises a variable speed pump and a switch.

According to a second aspect, the disclosure herein refers to a method for cooling an electrical aircraft propulsion system, comprising the steps of:
decreasing the temperature of a portion of a coolant below an operating temperature, acting this portion of the coolant as a thermal buffer, and
maintaining the rest of the coolant at the operation temperature.

Advantageously, the decreasing the temperature of a portion of a coolant below an operating temperature is made before the taking-off of the aircraft, and this portion of the coolant acts as a thermal buffer during the taking-off of the aircraft.

Furthermore, the decreasing of the temperature of a portion of the coolant at the operation temperature and the maintenance of the rest of the coolant at the operation temperature is preferably carried out bypassing the rest of the coolant.

According to a preferred embodiment, the decreasing of the temperature is made by one or more heat exchangers.

An objective of the subject matter herein is to disclose a system and a method which enhances the cooling capabilities of the cooling system during the take-off phase, especially during the beginning of this phase, when the aircraft speed is very limited.

The principle to alleviate the sizing of the ram air channels is overcooling the coolant of thermal management system while keeping the operating temperature of the fuel cell, in order not to penalize its performance or reliability.

Then, this extra cold temperature of the coolant provides a thermal buffer during the first part of the take-off phase, and therefore delaying the sizing of the ram air channels to a point where the aircraft speed is higher, and therefore less demanding for the ram air channels.

### BRIEF DESCRIPTION OF THE DRAWING

For a better understanding the above explanation and for the sole purpose of providing an example, a non-limiting drawing is included that schematically depicts a practical embodiment.

FIG. 1 is a diagrammatical view of the components forming part of the cooling system according to the disclosure herein.

### DETAILED DESCRIPTION

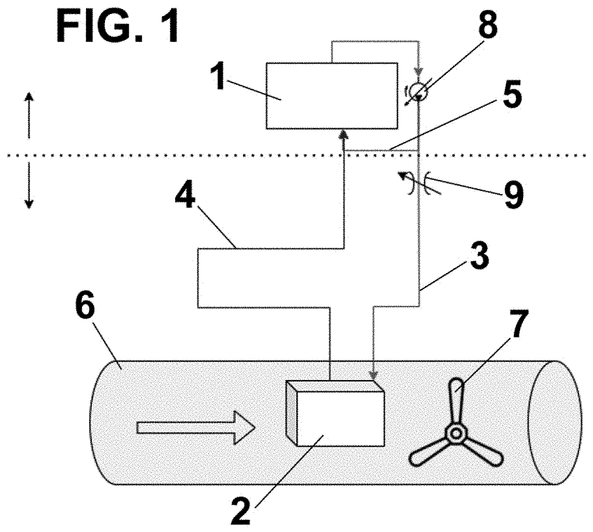

The cooling system according to the disclosure herein is diagrammatically shown in FIG. 1.

An electrical aircraft propulsion system requires a cooling system to remove the heat generated by the energy source, such as, e.g. fuel cells.

The cooling system according to the disclosure herein comprises an energy source 1 that drives the propulsion system, such as a fuel cell, and one or more heat exchangers 2 for cooling a coolant.

The one or more heat exchangers 2 are connected to the energy source 1 by a coolant circuit inside which a coolant circulates. In particular, the coolant circuit comprises a portion 3 from the fuel cell 1 to the heat exchanger 2, a portion 4 from the heat exchanger 2 to the fuel cell 1, and a bypass portion 5 that defines a loop from and to the fuel cell 1 (fuel cell loop) and a loop from and to the heat exchanger 2 (heat exchanger loop).

Furthermore, the cooling system according to the disclosure herein comprises one or more air channels 6 inside which the one or more heat exchangers 2 and one or more fans 7 are placed. The one or more heat exchangers 2 and the fan or fans 7 permit to cool the coolant generating an air flow through the heat exchanger 2.

The bypass portion 5 of the coolant circuit permits to recirculate the coolant to the energy source, o to circulate the coolant from the energy source to the one or more heat exchangers.

In the loop defined bypass portion 5 there is provided a variable speed pump 8, that regulates fast enough the inlet temperature and mass flow through the fuel cell 1.

Furthermore, the portion 3 of the coolant circuit from the fuel cell 1 to the heat exchanger 2 comprises a switch 9 for opening and closing the passage for coolant through this portion 3 of the coolant circuit.

When a fuel cell 1 is used to generate propulsive energy to the aircraft, since the fuel cell 1 generates a lot of heat, ambient temperature can be very hot, and the aircraft speed is very limited.

If the cooling system is sized to cover this flight phase, the resulting air channel size is significantly big, and the objective of the disclosure herein is to decrease its size.

By this bypass portion 5 in the coolant circuit, the temperature of a portion of a coolant can be decreased below an operating temperature, acting this portion of the coolant as a thermal buffer, maintaining the rest of the coolant at the operation temperature.

In particular, in the method of the disclosure herein, according to the shown embodiment, the fan or fans 7 can be operated in order to decrease the coolant temperature below the operating temperature of the fuel cell 1 before the take-off phase.

As a consequence, the coolant will be bypassed at fuel cell loop in order to maintain the fuel cell operating temperature, whereas the coolant in the heat exchanger loop decreases its temperature. This volume of coolant at lower temperature acts as a thermal buffer during the take-off phase.

When the take-off phase starts, the temperature of the coolant in the heat exchanger loop increases until it reaches approximately the operating temperature of the fuel cell 1.

The benefit of this method is the time required by the coolant of the heat exchanger loop to reach the operating temperature of the fuel cell 1. This extra time allows the aircraft to start the take-off procedure and therefore increase the aircraft speed before the coolant is at the fuel cell operating temperature.

The optimum temperature to be achieved by the coolant of the heat exchanger loop shall be determined in order to identify the optimum solution in terms of fan power requirement vs air channel size and air channel drag during the take-off phase.

Even though reference has been made to a specific embodiment of the disclosure herein, it is obvious for a person skilled in the art that the cooling system and method described herein is susceptible to numerous variations and modifications, and that all of the details mentioned can be substituted for other technically equivalent ones without departing from the scope of protection defined by the attached claims.

While at least one example embodiment of the invention(s) is disclosed herein, it should be understood that modifications, substitutions and alternatives may be apparent to one of ordinary skill in the art and can be made without departing from the scope of this disclosure. This disclosure is intended to cover any adaptations or variations of the example embodiment(s). In addition, in this disclosure, the terms “comprise” or “comprising” do not exclude other elements or steps, the terms “a”, “an” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A cooling system for an electrical aircraft propulsion system, comprising:
an energy source to drive the propulsion system;
one or more heat exchangers for cooling a coolant, the one or more heat exchangers being connected to the energy source by a coolant circuit;
one or more air channels inside which the one or more heat exchangers are disposed;
wherein the coolant circuit comprises a bypass portion that:
recirculates the coolant to the energy source; or
circulates the coolant from the energy source to the one or more heat exchangers.

2. The cooling system for an electric aircraft propulsion system according to claim 1, wherein the one or more air channels comprises one or more fans.

3. The cooling system for an electric aircraft propulsion system according to claim 1, wherein the energy source is a fuel cell.

4. The cooling system for an electric aircraft propulsion system according to claim 1, wherein the coolant circuit comprises a variable speed pump.

5. The cooling system for an electric aircraft propulsion system according to claim 1, wherein the coolant circuit comprises a switch.

6. A method for cooling an electrical aircraft propulsion system, comprising:
decreasing a temperature of a portion of a coolant below an operating temperature, acting this portion of the coolant as a thermal buffer; and
maintaining a rest of the coolant at the operating temperature.

7. The method for cooling an electrical aircraft propulsion system according to claim 6, wherein the decreasing the temperature of a portion of a coolant below an operating temperature is carried out before taking-off of the aircraft, and the portion of the coolant acts as a thermal buffer during the taking-off of the aircraft.

8. The method for cooling an electrical aircraft propulsion system according to claim 6, wherein the decreasing of the temperature of a portion of the coolant at the operating temperature and the maintaining of the rest of the coolant at the operating temperature is carried out bypassing the rest of the coolant.

9. The method for cooling an electrical aircraft propulsion system according to claim 6, wherein the decreasing of the temperature is made by one or more heat exchangers.
